(19) United States
(12) Patent Application Publication
(10) Pub. No.: US 2008/0210698 A1
(43) Pub. Date: Sep. 4, 2008

(54) TOROIDAL CONTAINER BAND

(76) Inventors: Joey N. Mendelsohn, Hermosa, CA (US); Lisa M. Mendelsohn, Hermosa, CA (US)

Correspondence Address: GATES & COOPER LLP;HOWARD HUGHES CENTER, 6701 CENTER DRIVE WEST, SUITE 1050, LOS ANGELES, CA, 90045, US

(21) Appl. No.: 12/040,691

(22) Filed: Feb. 29, 2008

Related U.S. Application Data
(60) Provisional application No. 60/892,446, filed on Mar. 1, 2007.

(51) Int. Cl. B65D 25/00; B23P 11/00

(52) U.S. Cl. 220/694; 29/428

(57) ABSTRACT

A toroidally shaped container band provides the ability to easily distinguish a container upon which the band is placed. A strip of flexible material having a first end and a second end is obtained. The strip of flexible material is formed into a toroidal shape. The first end is attached to the second end. The strip of flexible material is placed onto a container. Once placed onto the container, the flexible material assumes a shape of the container.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

Provisional Application Ser. No. 60/892,446, filed Mar. 1, 2007, by Joey N. Mendelsohn and Lisa M. Mendelsohn, entitled “TOROIDAL CONTAINER BAND,” attorneys' docket number 219.1-US-P1.

### BACKGROUND OF THE INVENTION

1. Field of the Invention

The embodiment of the invention relates generally to beverage accessories and more particular to a water bottle band for personalization and identification of one's water bottle, other beverage, or other cylindrical or toroidal shaped container or structure.

2. Description of the Related Art

Promotional companies have been offering permanent custom water bottle labels to personalize your own water for many years now. The prior art provides a way for companies to promote their business by giving away these items for promotional use; however, the prior art has the following limitations:
The label is not removable.
The label is the same on every water bottle, so personalization is limited.
The label tears easily because of the material.
The label is in the same location on all bottles.
The label is not stretchable.

### SUMMARY OF THE INVENTION

The embodiment of the invention relates generally to beverage accessories and more particular to a water bottle band for personalization and identification of ones water bottle or other beverage.

The band may be comprised of an elastic stretchable material which may be secured into the toroidal shape with a stitch, piece of hook and loop fasteners (e.g., Velcro™), glue, staple or some other material that can bind the band together. The band may also be configured to be placed upon a bottle or can, however, generally a water bottle.

The band is printed with custom designs to encourage children to personalize their own water bottle in a fun and unique way. A potential advantage of an embodiment of the invention may include the ability for persons to identify their own water bottle, container, or structure, which will decrease the number of children contracting an illness by contact of someone else's container. Other advantages may include saving money since the waste factor will decrease because less unclaimed drinks will be left over. Another advantage may include kids being encouraged to drink more water and live a healthier life. Another advantage may include having a better grip while drinking the beverage. Another advantage may include being able to fit an embodiment of the invention into one's pocket and recovering/returning to its toroidal shape and function when removed from the pocket. Accordingly, the material of the band is flexible and has the ability to repeatedly form a toroidal shape regardless of the shape that the band is stored in (i.e., whether stored in packaging, placed into one's pocket, crumpled into a ball, etc.).

### BRIEF DESCRIPTION OF THE DRAWINGS

Referring now to the drawings in which like reference numbers represent corresponding parts throughout:

FIG. 1 is a flowchart describing a method for utilization of a band, in accordance with one of more embodiments of the invention;

FIG. 2 is a flowchart illustrating the construction of a toroidal container band in accordance with one or more embodiments of the invention;

FIG. 3 shows an image of a toroidal shaped material that may be held together by a stitch or other method to form a seam in accordance with one or more embodiments of the invention;

FIG. 4 shows an image of a flat piece of material that is not seamed in accordance with one or more embodiments of the invention;

FIG. 5 shows an image of a water bottle band from a top-down view/perspective in accordance with one or more embodiments of the invention;

FIGS. 6A and 6B illustrate images of toroidal bands applied to bottles in accordance with one or more embodiments of the invention; and

FIG. 7 illustrates a dye sublimation cartridge used in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Overview

A water bottle band for personalization and identification that may be comprised of a band of elastic material that is stitched together to form a toroidal shape and is configured to be placed upon a bottle or can, however, generally a water bottle.

### Toroidal Band Details

One or more embodiments of the invention overcomes the disadvantages of the prior art. In one or more embodiments, the band is removable. Further, the material may be stretchable and very durable, which implies the property of resisting deformation by stretching and the ability to recover shape quickly when the deforming force or pressure is removed. Consequently, this will enable the band to last a long time by not falling apart and being reusable. The water band may also be customized to each individual and the minimum order may be very low (e.g., bands may be ordered individually) based on the ability to purchase customized bands in packs of four (4). The band may also be positioned on different parts of the bottle as well (e.g., upper portion, lower portion, middle portion, diagonally, vertically, horizontally, etc.). The flexibility and stretchability of the material of the band provides the ability to form the band into a shape that may be placed on a variety of shaped bottles or devices.

One or more embodiments of the invention may promote a brand of an unrelated product as well.

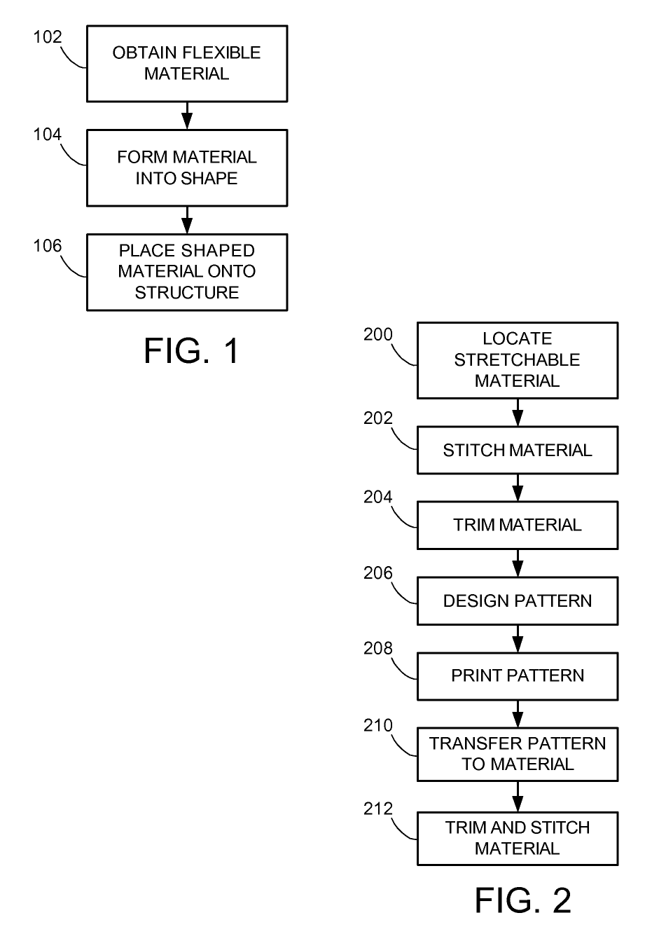

FIG. 1 is a flowchart describing a method for utilization of a band, in accordance with one of more embodiments of the invention. Step 100 describes obtaining a flexible material (e.g., a strip of flexible material having two ends—a first end and a second end). The material may be comprised of rubber, cotton, elastic, latex, neoprene, terry cloth, silicone, polyester, spandex, terylene, paper, cardboard, foam, plastic, glass, metal or any other material that can be formed into a toroidal shape. Further, the material may be of a type that allows a person (child or adult) to draw on the container and further customize the band (e.g., using a marker, pen, ink-based utensil, etc.). Further, in one or more embodiments, any writing upon the material may be easily removed using soap and water, a wash, or other type of chemical. In addition, a custom design may be printed onto the strip of flexible material (e.g., using a dye-sublimation printing process as described in further detail below).

Step 102 describes forming the material (i.e., strip of material) into a circular or toroidal shape. The material need not be limited to the simple toroid shape described and illustrated herein, but may be of any shape suitable for covering a portion of a user's beverage. Thus, as used herein, the term “toroidal” includes any surface or shape generated by a closed curve or line (e.g., bezier curve) rotating about, but not intersecting or containing, an axis in its own plane. It may be noted that such a forming may consist of simply securing the ends of the material to each other (e.g., through stitching, gluing, hot gluing, hook and loop fastener, etc.). Such a forming step 104 may further include attaching the first end to the second end (e.g., via stitching). In this regard, the container band may also be viewed as containing a coupling area that couples or attaches the two ends of the strip together.

Step 104 describes placing the material upon a container (e.g., a beverage container). The beverage container may be a bottle, can, sippy cup, container, cup, water bottle, coffee drink, juice box, milk container or any other container containing items that can be digested. Alternatively, the material can be placed on any toroidal or similarly shaped container regardless of the contents therein. For example, such a material may be placed around a baseball bat, free weights (e.g., dumbbells and/or barbells), hairspray, aerosol container, stroller handle, grocery cart handle, telephone headset, flashlight, etc. Accordingly, the shape of the band assumes and takes the shape of the device/container upon which it is placed. In this regard, since the ends of the band may be secured to each other, the band may be stretched and slid onto the device/container or may be secured into the shape of the device/container after placing or wrapping the band around the device (e.g., using hook and loop fasteners). Thus, the sequence in which the band forms into the shape and is placed onto the container may be interchangeable.

In view of the above, one or more embodiments of the invention can be accomplished by using the following steps as set forth in FIG. 2:

At step 200, a stretchable material (such as elastic) is located/obtained.

At step 202, the elastic material is stitched together (e.g., with spandex and latex) to give it a smoother surface and is formed into large rolls of material.

At step 204, a large rectangular shaped piece of the stretchable material that will be used to print on is trimmed from the stitched elastic material.

At step 206, a colorful pattern is designed (e.g., on the computer using a graphics program such as Microsoft™ Paint, Adobe™ Illustrator™, etc. The pattern is also saved in an appropriate format (e.g., JPG, GIFF, AI, etc.).

At steps 208 and 210, the pattern is printed (e.g., using a dye-sublimation printing process [see below for definition]) onto a special type of paper and is transferred to the elastic material (e.g., using heat).

At step 212, the printed elastic is then trimmed to a smaller size (e.g., 7½″×2″), and stitched along the 2″ length to form a toroidal shape.

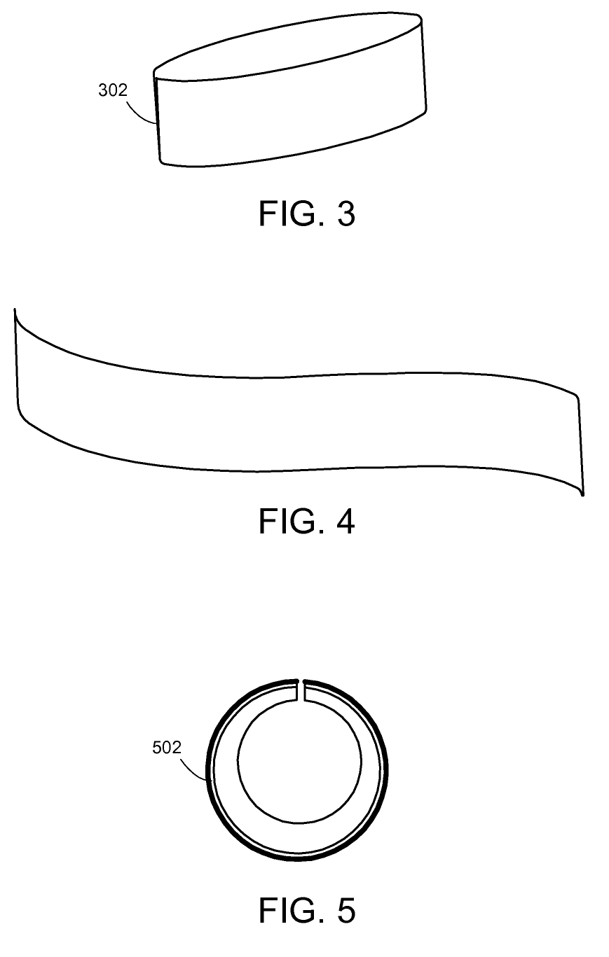

FIG. 3 through FIG. 7 are renderings of a water bottle band, in accordance with one or more of the embodiments of the invention. FIG. 3 shows an image of a toroidal shaped material that may be held together by a stitch or other method to form a seam 302.

FIG. 4 shows an image of a flat piece of material that is not seamed.

FIG. 5 shows an image of a water bottle band from a top-down view/perspective. As illustrated, the band does not have a seam 302 and is arranged in a toroidal shape with the bold area 502 closest to the viewpoint.

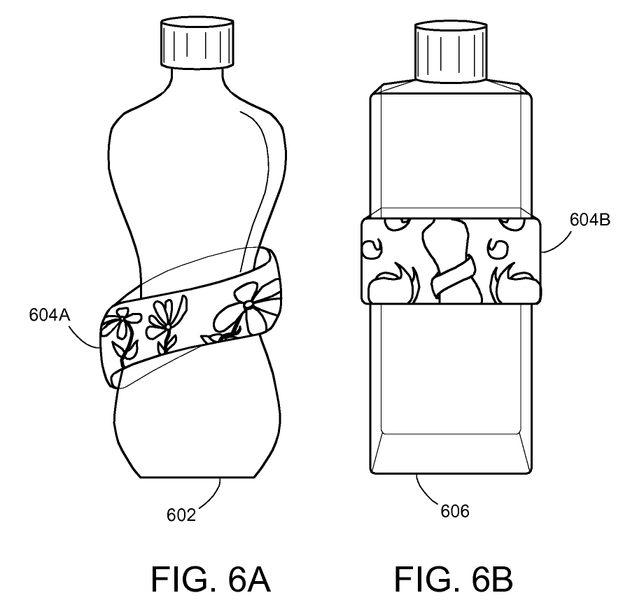

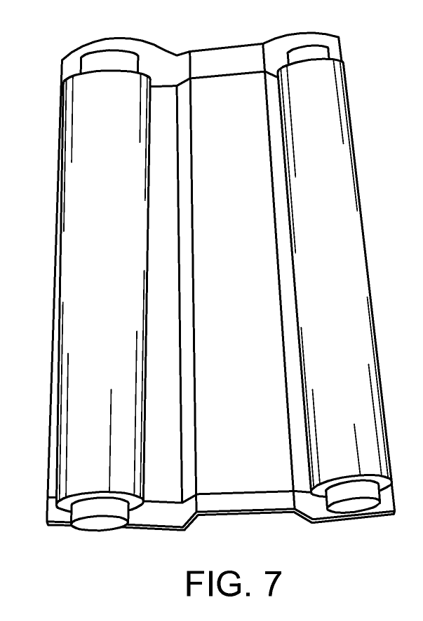

FIGS. 6A and 6B illustrate images of toroidal bands applied to bottles in accordance with one or more embodiments of the invention. FIG. 6A shows an image of a relatively circular shaped water bottle 602 with a printed band 604A wrapped around the middle of the bottle 602. FIG. 6B shows an image of a square shaped container 606 with a printed band 604B wrapped around the middle of the bottle. As illustrated, bands 604A and 604B may have different designs the can be customized as desired. Such designs may be integrated into the bands using any known type of

In addition to the above, preferred embodiments of the invention consist of the toroidal shaped band that has a height of at least 1.5 inches. However, embodiments may utilize bands having any height or dimensions in accordance with the invention.

### Dye-Sublimation Printing

FIG. 7 illustrates a dye sublimation cartridge used in accordance with one or more embodiments of the invention. Dye sublimation is a printing process that uses the process of sublimation to print full-color images onto a variety of substrates, including paper and canvas print. A small heater is used to vaporize the solid dye material, which then solidifies upon the paper. As this type of printer allows extremely fine control of the primary color ratios it is possible to obtain a good quality picture even with relatively low printer resolution, as compared to other printer types of similar resolution.

Tektronix™ “Phaser” computer printers were one of the first examples of the use of the dye sublimation process in a mass-produced printer. Dye sublimation can also be used as an indirect printing process. Standard black and white laser printers are capable of printing on plain paper using a special “transfer toner” containing sublimation dyes which can then be permanently heat transferred to T-shirts, hats, mugs, metals, puzzles and other surfaces.

Dye-Sublimation Fabric Printing

A different type of dye-sublimation printing can be used to print on fabrics and clothing, (for example t-shirts). These printers are similar to inkjet printers in that they spray ink onto a sheet of paper but the ink is actually dye-sublimation ink held in a liquid solvent, (water for example), and is then applied to a donor material, (a special type of paper). The image on the paper is a reverse image of the final design and when it is dry it is placed onto the fabric and heated so the completed image is transfered onto the material via the dye-sublimation process, (i.e. the dye turns into the gas and permeates the actual fibres of the material and then solidifies).

### CONCLUSION

This concludes the description of the preferred embodiment of the invention. The following describes some alternative embodiments for accomplishing the present invention. For example, any type of fabric may be placed onto any type or shape of container in accordance with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for utilizing a flexible band, comprising:
obtaining a strip of flexible material having a first end and a second end;
forming the strip of flexible material into a toroidal shape;
attaching the first end to the second end; and
placing the strip of flexible material onto a container, wherein the flexible material assumes a shape of the container.

2. The method of claim 1, wherein the attaching comprises stitching the first end to the second end.

3. The method of claim 1, wherein the container comprises a beverage container.

4. The method of claim 1, further comprising printing a custom design on the strip of flexible material.

5. The method of claim 4, wherein the printing comprises a dye-sublimation printing process.

6. The method of claim 1, wherein the obtaining the strip of flexible material comprises:
obtaining a stretchable material;
stitching together the stretchable material to provide a smooth surface;
forming the stitched stretchable material into a roll of flexible fabric; and
trimming a rectangular shaped piece of the stretchable material from the roll, wherein the rectangular shaped piece comprises the strip of flexible material.

7. A toroidal container band comprising:
a strip of flexible material having a first end and a second end, wherein the strip of flexible material is formed into a toroidal shape;
a coupling area that attaches the first end to the second end; and
wherein the coupled strip of flexible material assumes a shape of a container upon which it is placed.

8. The toroidal container band of claim 7, wherein the coupling area comprises a stitching of the first end to the second end.

9. The toroidal container band of claim 7, wherein the container comprises a beverage container.

10. The toroidal container band of claim 7, wherein the strip of flexible material further comprises a custom design printed on the flexible material.

11. The toroidal container band of claim 10, wherein the custom design comprises a dye-sublimation printed custom design.

12. The toroidal container band of claim 7, further comprising:
a stretchable material having a smooth surface that has been stitched together;
a roll of flexible fabric formed by the stretchable material;
wherein the strip of flexible material further comprises a rectangular shaped piece of the stretchable material that has been trimmed from the roll.
